(19) United States
(12) Patent Application Publication
(10) Pub. No.: US 2015/0326435 A1
(43) Pub. Date: Nov. 12, 2015

(54) PARAMETER SETTING SYSTEM, PROGRAM MANAGEMENT APPARATUS, AND INFORMATION PROCESSING APPARATUS

(71) Applicants: Takayuki TAMURA, Chiyoda-ku, Tokyo (JP); Mamoru KATO, Chiyoda-ku, Tokyo (JP)

(72) Inventors: Takayuki TAMURA, Tokyo (JP); Mamoru KATO, Tokyo (JP)

(73) Assignee: Mitsubishi Electric Corporation, Chiyoda-ku, Tokyo (JP)

(21) Appl. No.: 14/646,143

(22) PCT Filed: Dec. 5, 2012
(86) PCT No.: PCT/JP2012/081563

§ 371 Date: May 20, 2015

(51) Int. Cl. H04L 12/24; H04L 29/12; H04L 29/08

(52) U.S. Cl. CPC H04L 41/0816; H04L 67/10; H04L 61/2015

(57) ABSTRACT

A server computer manages a setting program which is used for setting parameters. An operating PC conducts communication with a server computer and a device to which parameters have not been set. The server computer sends a setting program to the operating PC based on a request from the operating PC. The operating PC receives the setting program from the server computer, executes the received setting program, generates a parameter setting request message which includes a setting target parameter to be set to the device and requests setting of the setting target parameter, and sends the generated parameter setting request message to the device.

### TECHNICAL FIELD

The present invention relates to technique to set parameters on a device with network functions.

The present invention relates to technique to set network parameters such as, for instance, an IP (Internet Protocol) address, a default gateway IP address, an HTTP (HyperText Transfer Protocol) proxy server URL (Uniform Resource Locator), an SSL (Secure Socket Layer) client certificate, and the like on a device.

### BACKGROUND ART

Upon starting to use a device with network functions by connecting to a LAN (Local Area Network), first, it is required to set an IP address on the device.

Since a personal computer (PC), a smartphone and the like are provided with a console, the user can set the IP address directly on the device; on the other hand, in case of a device without a console (or the device for which the console is not always available), it is general to set the IP address by either of the following methods.

(1) Manual Setting (Off-Line PC Connection) Method

The operating PC and the device are connected with a status in which the operating PC and the device are connected by an accessing method other than LAN (via a serial interface and the like) or a 1-to-1 network connection (using an IP address set at the factory shipment), separated from the LAN of the installation site, and the IP address is set using a setting interface provided at the device.

(2) Automatic Setting (DHCP) Method

A DHCP (Dynamic Host Configuration Protocol) server is placed on the LAN, an exchange of an IP address obtainment request and a setting response is carried out with the device using a broadcast address.

Patent Literature 1 discloses a method to find a device in which an IP address has not been set using a computer on which an exclusive program is mounted and set the IP address.

This method can be deemed as the DHCP method in which a sending order of packets is changed.

### CITATION LIST

### Patent Literature

Patent Literature 1: JP2004-48649A

### SUMMARY OF INVENTION

### Technical Problem

The above device parameter setting methods include the following problems:

### (1) Manual Setting (Off-Line PC Connection) Method

It is necessary to connect the device with the operating PC only for setting the IP address, which complicates the physical operation.

In particular, a cable for connection vary depending on whether it is a straight connection or a cross connection or on a difference of a shape of a connector; and it becomes more difficult to select a proper cable as the number of types of the devices to be handled increases.

Further, it is necessary to previously set a serial connection parameter (baud rate and the like) or an IP address also for the operating PC.

### (2) Automatic Setting (DHCP) Method

In order to access the device from the outside, it is necessary to previously register a device-specific MAC (Media Access Control) address in the DHCP server to set a fixed IP address.

In a case where the device installer himself is unable to register on the DHCP server and has to delegate the registration to the administrator in charge, it takes time to apply and so on.

Further, in a case where a target to be accessed by the device is a server on the Internet, it is generally required to access through a HTTP proxy server from a company.

Such a case requires to access a setting interface of the device from the operating PC through the LAN, and to set a URL and the like of the proxy server.

Like the above, there is a problem that the conventional parameter setting methods of the device require a complicated operation to set the IP address or connect to the server on the Internet, and thereby increasing the cost accompanied to the introduction or transfer of the device.

Further, in order to implement a device which provides value-added function such as automatic software update and the like in cooperation with the server on the Internet, it is necessary to solve the above problem.

In view of these matters, the present invention aims to set parameters to a device, to which parameters have not been set, with a simple operation.

### Solution to Problem

According to the present invention, a parameter setting system includes:

a program management apparatus that manages a setting program which is used for setting a parameter; and

an information processing apparatus that conducts communication with the program management apparatus and a parameter-unset device to which a parameter has not yet been set, the information processing apparatus being able to execute the setting program,

the program management apparatus sends the setting program to the information processing apparatus based on a request from the information processing apparatus, and

the information processing apparatus requests the program management apparatus to send the setting program, receives the setting program from the program management apparatus, executes the received setting program, generates a parameter setting request message that includes a setting target parameter to be set to the parameter-unset device and requests setting of the setting target parameter, and sends the generated parameter setting request message to the parameter-unset device.

### Advantageous Effects of Invention

In the present invention, the program management apparatus sends a setting program to an information processing apparatus, the information processing apparatus executes the setting program, generates a parameter setting request message, and sends the generated parameter setting request message to a parameter-unset device.

With this feature, parameters can be set to the parameter-unset device with a simple operation.

### BRIEF DESCRIPTION OF DRAWINGS

FIG. 1 is a diagram illustrating a configuration example of a parameter setting system related to a first embodiment.

FIG. 2 is a diagram illustrating a configuration example of a server computer related to the first embodiment.

FIG. 3 is a diagram illustrating an example of a setting parameter related to the first embodiment.

FIG. 4 is a diagram illustrating an example of a PC setting parameter related to the first embodiment.

FIG. 5 is a diagram illustrating an example of a device information table related to the first embodiment.

FIG. 6 is a diagram illustrating an example of setting information related to the first embodiment.

FIG. 7 is a diagram illustrating an example of a user information table related to the first embodiment.

FIG. 8 is a diagram illustrating a screen example of the Web browser related to the first embodiment.

FIG. 9 is a diagram illustrating a setting program generation request related to the first embodiment.

FIG. 10 is a diagram illustrating a structure example of a setting program related to the first embodiment.

FIG. 11 is a diagram illustrating an example of information of a parameter region related to the first embodiment.

FIG. 12 is a flowchart illustrating an operation example of a server computer related to the first embodiment.

FIG. 13 is a flowchart illustrating an operation example of an operating PC related to the first embodiment.

FIG. 14 is a diagram illustrating an example of a parameter setting request message related to the first embodiment.

FIG. 15 is a flowchart illustrating an operation example of a device related to the first embodiment.

FIG. 16 is a diagram illustrating an example of a device registration request related to the first embodiment.

FIG. 17 is a flowchart illustrating an operation example of a server computer related to the first embodiment.

FIG. 18 is a diagram illustrating a configuration example of a parameter setting system related to a second embodiment.

FIG. 19 is a diagram illustrating an example of a setting program generation request related to the second embodiment.

FIG. 20 is a diagram illustrating an example of hardware configuration of a server computer and so on related to the first to fourth embodiments.

### DESCRIPTION OF EMBODIMENTS

### Embodiment 1

The present embodiment will explain a configuration to set a network parameter, with a simple operation, to a device without (not always provided with) a user input/output apparatus (console).

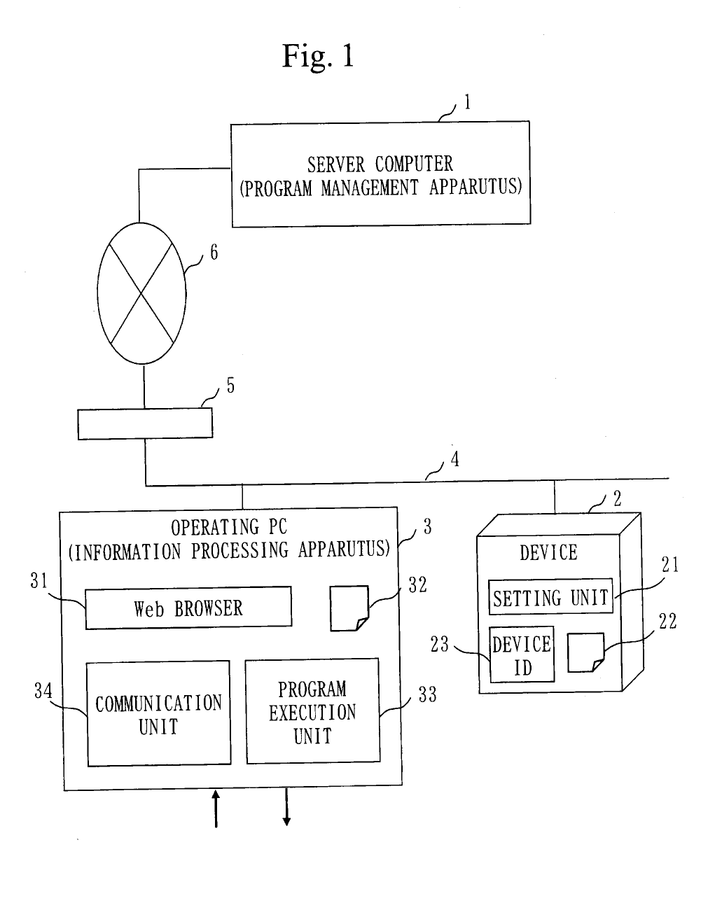

FIG. 1 is a diagram illustrating a configuration example of a parameter setting system related to the present embodiment.

A reference numeral 1 denotes a server computer, 2 denotes a device which is a target of setting a parameter, and 3 denotes an operating PC (hereinafter, also simply referred to as a PC).

A reference numeral 4 is a LAN to connect the device 2 and the PC 3, 5 is a network router apparatus connected to the LAN 4, and 6 is an external network connected to the network router apparatus 5 and the server computer 1.

The server computer 1 is, for instance, a computer operated by a dealer or a manufacturer of the device 2, and the operating PC 3 is, for instance, a computer owned by a customer who purchases the device 2.

The server computer 1 corresponds to an example of a program management apparatus, the operating PC 3 corresponds to an example of an information processing apparatus, and the device 2 corresponds to an example of a parameter-unset device.

The server computer 1 can be implemented as a computer to which a CPU (Central Processing Unit), a RAM (Random Access Memory), a ROM (Read Only Memory), a secondary storage apparatus, a network interface, and a console are connected with a bus.

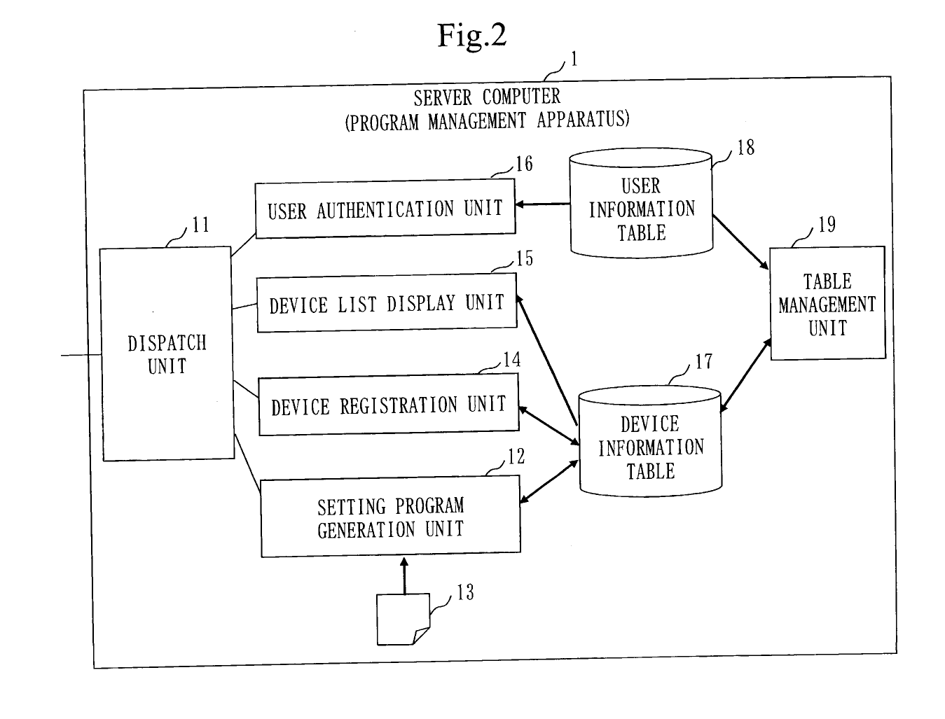

The server computer 1 is provided with, as illustrated in FIG. 2, a dispatch unit 11, a setting program generation unit 12, a device registration unit 14, a device list display unit 15, and a user authentication unit 16.

Each component of 11, 12, and 14 to 16 is, for instance, implemented as a part of application program, and executed by the CPU.

The dispatch unit 11 receives a request from the outside, calls out an appropriate component (either of components of 12, 14 to 16) according to a type of the request, receives the result, and sends the result as a response to a source of the request of the outside.

The secondary storage apparatus of the server computer 1 stores setting program execution codes 13, a device information table 17, and a user information table 18.

The device information table 17 and the user information table 18 are generated, updated, and deleted by the table management unit 19.

The device 2 is provided with a setting unit 21, and stores a rewritable setting parameter 22, and an unrewritable and device-specific device ID 23.

The device 2 can be implemented as a computer to which the CPU, the RAM, the ROM, and the network interface are connected with the bus and which does not have a console (is not always provided with a console).

The operating PC 3 can be also implemented as a computer to which the CPU, the RAM, the ROM, the secondary storage apparatus, the network interface, and the console are connected with the bus.

Further, the operating PC 3 is provided with a Web browser 31 and stores a PC setting parameter 32.

In addition, the operating PC 3 is provided with a program execution unit 33 executing a setting program 122, which will be discussed later, and a communication unit 34 communicating with the server computer 1 and the device 2.

The external network 6 may include a plurality of network apparatuses or a server computer.

For instance, the external network 6 may include an HTTP proxy server, a firewall apparatus, a network router apparatus, and the like.

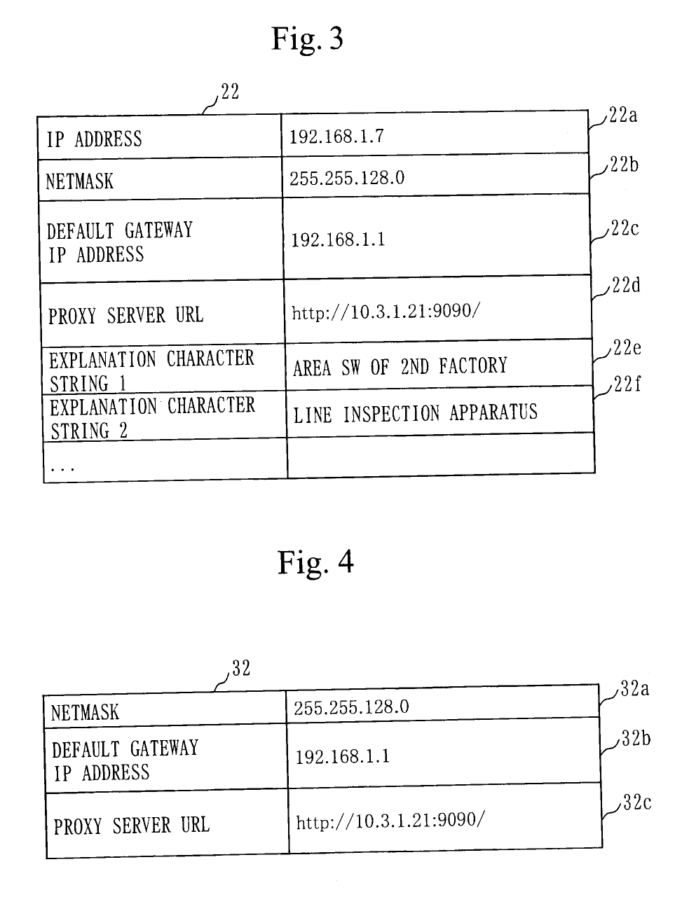

FIG. 3 shows an example of a type and a value of information included in the setting parameter 22.

The setting parameter 22 is composed of an IP address 22a, a netmask 22b, a default gateway IP address 22c, a proxy server URL 22d, an explanation character string 1 22e, an explanation character string 2 22f, and the like.

FIG. 4 shows an example of a type and a value of information included in the PC setting parameter 32.

The PC setting parameter 32 is composed of a netmask 32a, a default gateway IP address 32b, and a proxy server URL 32c.

The PC setting parameter 32 is not necessarily a single file and the like, but is a value stored in the memory apparatus and read by an operating system of the operating PC 3 with a specific method.

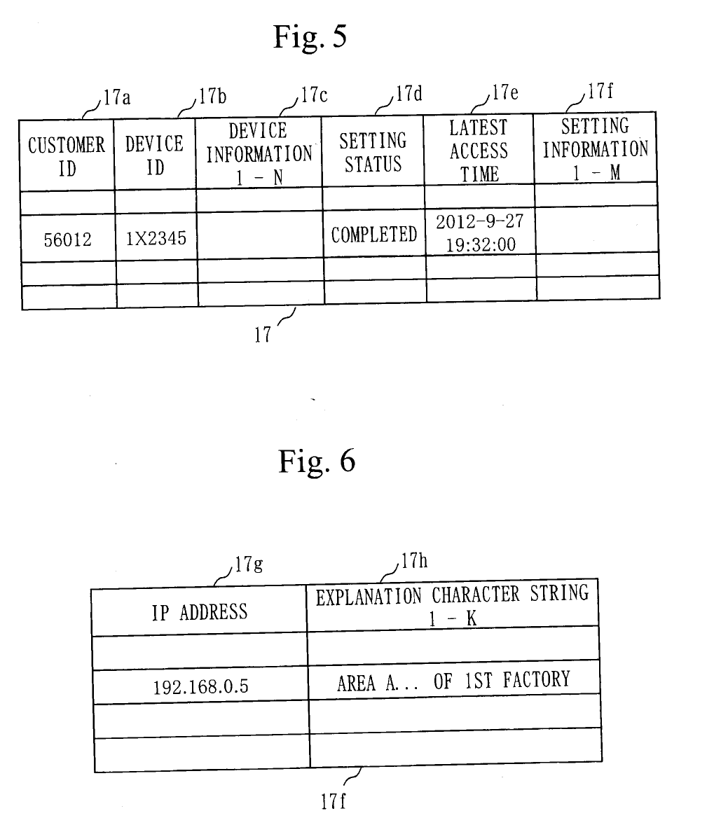

FIG. 5 shows an example of a data item and a value of the device information table 17.

The device information table 17 is composed of a set of lines corresponding to each device, and each line includes a customer ID 17a, a device ID 17b, device information 1 to N 17c, setting status 17d, a latest access time 17e, and setting information 1 to M 17f.

The customer ID 17a is information for the server computer to identify uniquely a customer who purchased the corresponding device.

Each device is identified by the device ID 17b, and supplemental information by the dealer or manufacturer can be stored in the device information 1 to N 17c.

The setting status 17d is information showing whether or not parameter setting is completed to the corresponding device.

The latest access time 17e records the latest time of access to the server computer 1 which is automatically done by the device to which the parameters have been set; if this value is older than the current time by a predetermined length of time, it can be deemed that the device has lost a valid network access environment.

The setting information 1 to M 17f is information which can be set by the customer to the corresponding device, for instance, as illustrated in FIG. 6, the IP address 17g and the explanation character string 1 to K 17h.

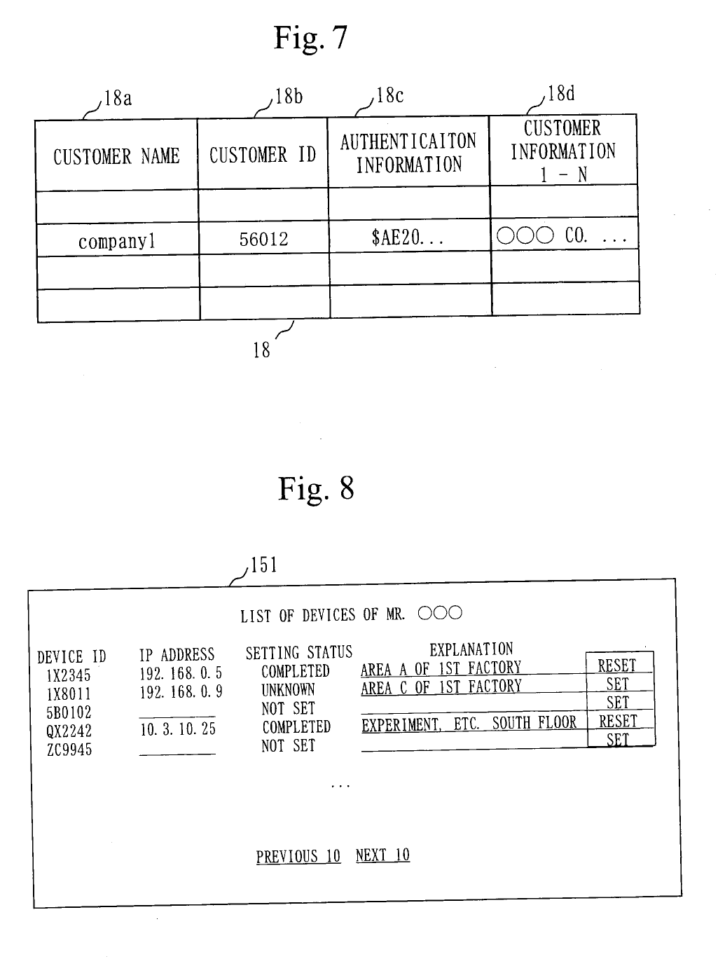

FIG. 7 shows a data item of the user information table 18.

The user information table 18 is composed of a customer name 18a, a customer ID 18b, authentication information 18c, and customer information 1 to N 18d.

In FIG. 1, a user who is an owner of the device 2 accesses the user authentication unit 16 of the server computer 1 via the Web browser 31 of the PC 3, and the user authentication unit 16 carries out authentication of the user using information stored in the user information table 18.

If the authentication succeeds, the user authentication unit 16 issues an authenticated token to the Web browser 31, so that the subsequent access to the device list display unit 15 and the setting program generation unit 12 should succeed.

FIG. 8 illustrates an example of a screen 151 displayed on the Web browser 31 when the authenticated user accesses the device list display unit 15 from the Web browser 31.

The screen 151 of FIG. 8 illustrates the result of data obtained from the device information table 17 by the device list display unit 15 for all the devices owned by customers including the user.

As illustrated in FIG. 8 as an example, the screen 151 shows the device ID, the IP address, the setting status, and the explanation character string, and as well buttons for instructing setting execution.

The setting status “unknown” is assigned to the device to which the parameter has been set and whose latest access time 17e of the device information table 17 is older than the current time by the predetermined length of time.

Here, it is assumed that when a value is set in an input column on the screen 151, and a setting execution button is pressed, an access to the setting program generation unit 12 is performed.

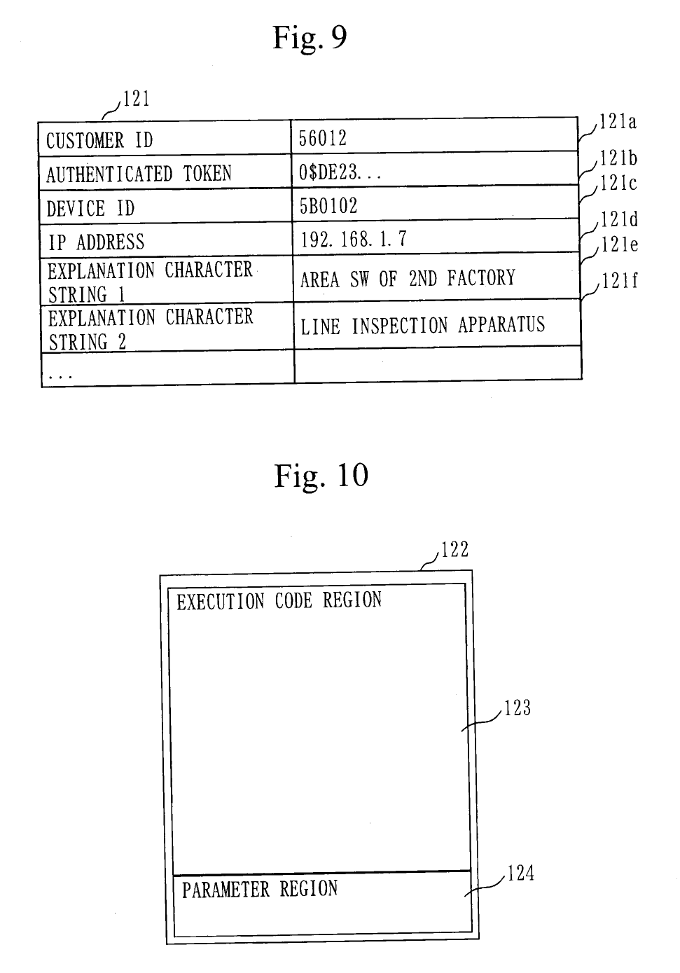

FIG. 9 illustrates a type and an example of information included in a request from the outside (a setting program generation request 121) which the setting program generation unit 12 receives at this time.

The setting program generation request 121 is composed of a customer ID 121a, an authenticated token 121b, a device ID 121c, an IP address 121d, an explanation character string 1 121e, an explanation character string 2 121f, and the like.

Among the above, the IP address 121d and the explanation character strings should be entered using the screen 151.

FIG. 10 illustrates a structure of a setting program 122 which the setting program generation unit 12 sends as a response to a source of the request.

The setting program 122 is composed of an execution code region 123 and a parameter region 124.

In the execution code region 123, program codes are written in a form being executable by the PC 3.

In the parameter region 124, parameters to be set in the device 2 are written.

The parameter region 124 can be unified with the execution code region 123 using, for instance, resource of Windows (registered trademark) of Microsoft (registered trademark) which is a known operating system.

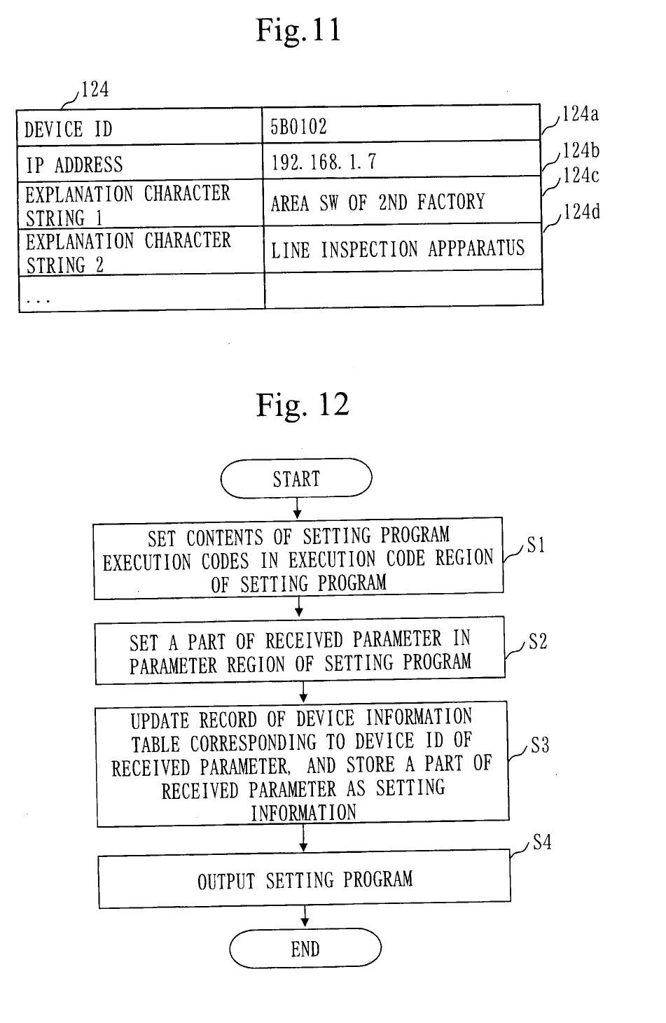

FIG. 11 illustrates an example of information included in the parameter region 124.

The parameter region 124 includes a device ID 124a, an IP address 124b, an explanation character string 1 124c, an explanation character string 2 124d, and the like.

Note that the IP address 124b included in the parameter region 124 corresponds to an example of a first communication parameter.

Further, the netmask 32a, the default gateway IP address 32b, and the proxy server URL 32c included in the PC setting parameter 32 (FIG. 4) correspond to examples of a second communication parameter.

That is, the communication parameter being specific to the device 2 for which parameters have not yet been set is classified as the first communication parameter, and the communication parameter being common to a plurality of devices including the device 2 for which parameters have not yet been set is classified as the second communication parameter.

In the following, with reference to flowcharts, an operation example of the parameter setting system according to the present embodiment will be explained.

FIG. 12 is a flowchart illustrating an operation example of the setting program generation unit 12 of the server computer 1.

Note that FIG. 12 shows an operation example after the setting program generation unit 12 receives the setting program generation request 121 as an input from the PC 3.

First at the step S1, the setting program generation unit 12 copies the contents of the setting program execution codes 13 to the execution code region 123 of the setting program 122 to be output to the PC 3.

Next at the step S2, the setting program generation unit 12 sets a part of information of the setting program generation request 121 received via the dispatch unit 11 to the parameter region 124 of the setting program 122.

Specifically, the setting program generation unit 12 sets the device ID 121c to the device ID 124a, the IP address 121d to the IP address 124b, the explanation character string 1 121e to the explanation character string 1 124c, and the explanation character string 2 121f to the explanation character string 2 124d, respectively.

Next at the step S3, the setting program generation unit 12 updates the record of the device information table 17 corresponding to the device ID 121c of the setting program generation request 121, and sets the IP address 121d, the explanation character string 1 121e, the explanation character string 2 121f, . . . of the setting program generation request 121 to the IP address 17g, the explanation character string 1, the explanation character string 2, . . . 17h, respectively.

Subsequently at the step S4, the setting program generation unit 12 sends the generated setting program 122 to the PC 3 via the dispatch unit 11, and terminates the operation.

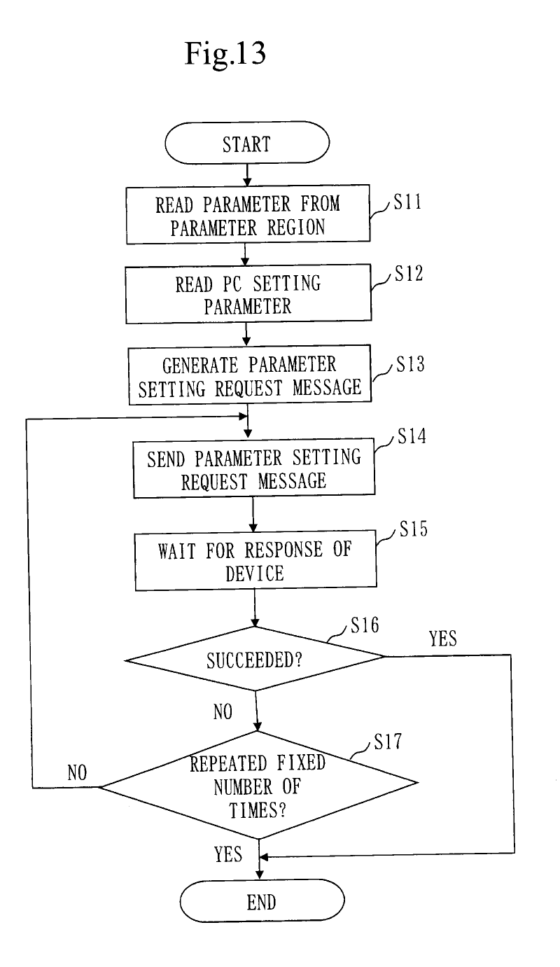

FIG. 13 is a flowchart illustrating an operation when the setting program 122 is downloaded by the Web browser 31 to the PC 3 and the program is executed.

That is, FIG. 13 illustrates a processing accomplished by executing the setting program 122 with the program execution unit 33 of the PC 3.

First at the step S11, the program execution unit 33 reads a value of parameter from the parameter region 124 by executing the setting program 122.

Next at the step S12, the program execution unit 33 reads the contents of the PC setting parameter 32 inside the PC 3 by executing the setting program 122.

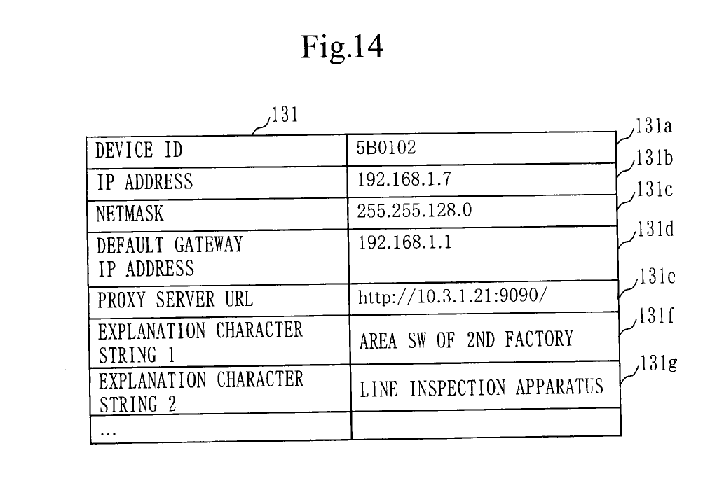

Subsequently at the step S13, the program execution unit 33 generates a parameter setting request message 131 of FIG. 14 based on the parameters which have been read at the step S11 and S12 by executing the setting program 122.

Specifically, the program execution unit 33 stores the device ID 124a, the IP address 124b, the explanation character string 1 124c, the explanation character string 2 124d, . . . of the parameter region 124 in the device ID 131a, the IP address 131b, the explanation character string 1 131f, the explanation character string 2 131g, . . . of the parameter setting request message 131, respectively.

Further, the netmask 32a, the default gateway IP address 32b, and the proxy server URL 32c which have been read from the PC setting parameter 32 are set to a netmask 131c, a default gateway IP address 131d, the proxy server URL 131e of the parameter setting request message 131, respectively.

Since the PC 3 and the device 2 are connected to the same LAN 4, the values of the netmask 131c, the default gateway IP address 131d, and the proxy server URL 131e are common, and thereby the values of the PC setting parameter 32 can be used instead of explicitly supplying values to the setting program generation unit 12.

Next at the step S14, the program execution unit 33 executes the setting program 122, and thereby sending out the parameter setting request message 131 to the LAN 4 using the communication unit 34 by specifying the broadcast address.

The use of the broadcast address enables the devices for which the IP address has not yet been set to receive the parameter setting request message 131.

At the subsequent step S15, the program execution unit 33 waits for the response to the parameter setting request message 131 from the device 2.

At the step S16, the program execution unit 33 determines whether or not a success response is received within a time-out period; and if received within the time-out period, the program execution unit 33 terminates the execution.

If the time-out occurs, or an error response is received, the process proceeds to the step S17.

At the step S17, the program execution unit 33 determines whether or not the number of repetitions reaches a prescribed value; and if not reached to the prescribed value, the program execution unit 33 repeats the process by returning to the step S14.

If the process is repeated a prescribed number of times, it is determined that the device parameter setting fails and the program execution unit 33 terminates the process.

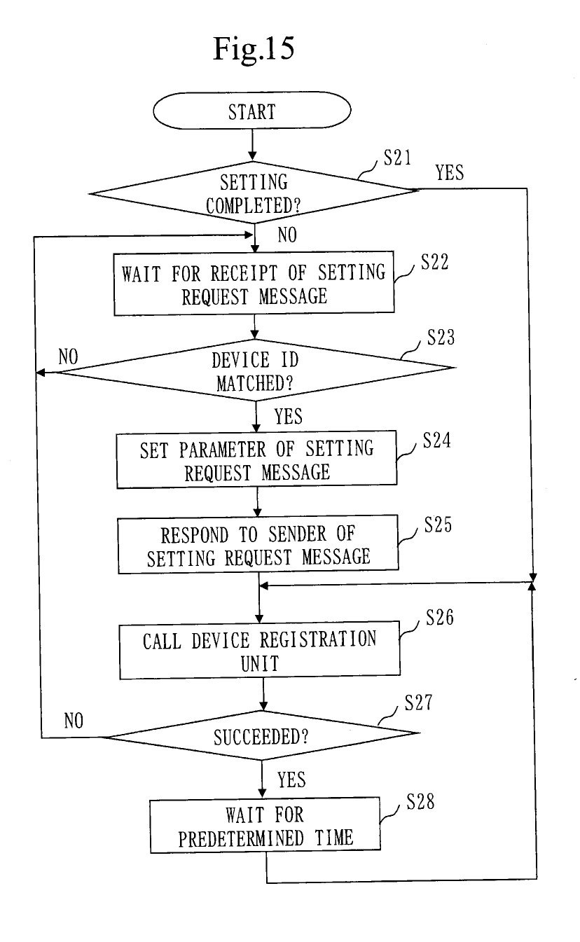

Next, an operation of the setting unit 21 of the device 2 will be explained with reference to a flowchart of FIG. 15.

The setting unit 21 determines, first at the step S21, whether or not the setting parameter 22 has been set, and if the setting parameter 22 has already been set, the process proceeds to the step S26.

If the setting parameter 22 has not yet been set, the setting unit 21 waits, at the step S22, until the parameter setting request message 131 is received from the LAN 4 (the time-out is indefinite).

Upon receiving the parameter setting request message 131, the process proceeds to the step S23, and the setting unit 21 determines whether or not the device ID 131a matches the device ID 23 of the device 2 itself.

If they do not match, the parameter setting request message 131 is ignored, and the process returns to the step S22.

Upon receiving the parameter setting request message 131 having the device ID 131a that matches the device ID 23 of the device 2, the setting unit 21 sets, at the step S24, the IP address 131b, the netmask 131c, the default gateway IP address 131d, and the proxy server URL 131e to the network interface and the like of the device 2, and as well stores the contents of the parameter setting request message 131 in the setting parameter 22.

This operation enables the device 2 to access the computer and the like on the LAN 4 and the external network 6 using the usual IP communication.

Next at the step S25, the setting unit 21 returns a setting success response to a sender of the parameter setting request message 131.

At the step S26, the setting unit 21 calls the device registration unit 14 of the server computer 1 via the server shown in the proxy server URL 131e. Details of the operation will be discussed later.

At the step S27, based on the result of the device registration unit 14, if the call succeeds, the process proceeds to the step S28, and if the call fails, the process returns to the step S22, and the processing is repeated.

At the step S28, after waiting for a predetermined time, the process returns to the step S26, and the processing is repeated.

As has been discussed, the setting unit 21, while the parameter setting does not succeed, repeats the parameter setting process based on the parameter setting request message 131.

Further, the setting unit 21, after the parameter setting succeeds, while the confirmation of setting validity does not succeed, repeats the confirmation of setting validity by calling the device registration unit 14.

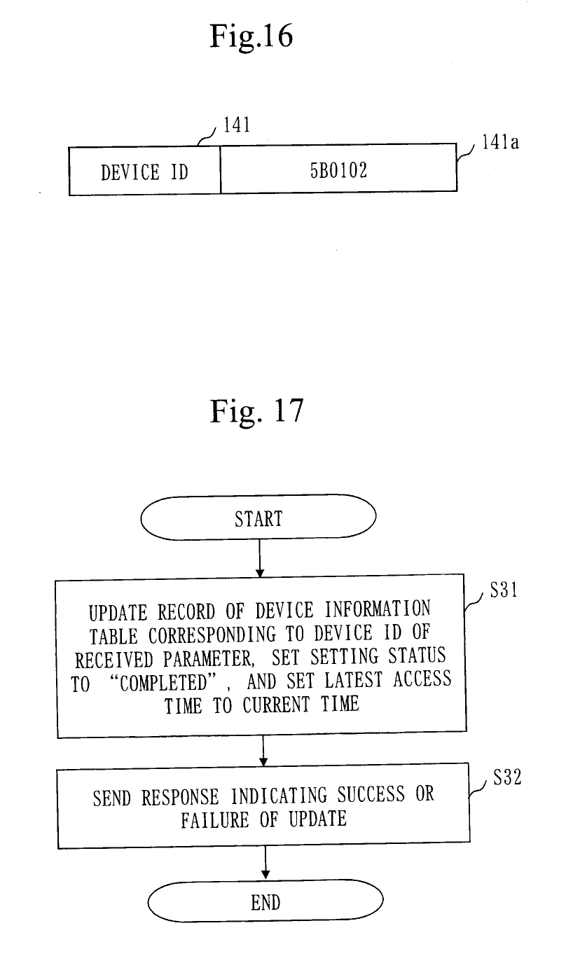

FIG. 16 illustrates a type and an example of information of a device registration request 141 when the setting unit 21 calls the device registration unit 14 of the server computer 1.

The device registration request 141 is composed of a device ID 141a.

FIG. 17 is a flowchart illustrating the operation of the device registration unit 14 of the server computer 1.

First at the step S31, the device registration unit 14 updates a record of the device information table 17 corresponding to the value of the device ID 141a received from the setting unit 21 of the device 2, sets the setting status 17d to “completed”, and sets the current time to the latest access time 17e.

Subsequently at the step S32, the device registration unit 14 sends a response indicating success or failure of the record update to the device 2 which is a source of the request.

As discussed above, according to the present embodiment, the information of the setting parameter is sent to the device 2 using the broadcast from the PC 3, and thereby the communication can be performed via the LAN 4 with the device 2.

Further, the parameter setting of the device 2 can be implemented without connection via another channel (off-line).

Further, since the parameter setting request message 131 includes the device ID 131a being specific to the device, even if a plurality of devices which are targets for setting the parameters exist in the LAN 4, the parameter setting can be carried out only for the intended device.

Further, since the setting program 122 downloaded from the server computer 1 is executed on the PC 3, the method according to the present embodiment can be applied to a PC as long as the PC can use the Web browser 31.

Consequently, software management operation such as pre-installation of the specific program, updating the installed program and the like can be eliminated.

Further, since the setting program 122 includes the IP address specified by the user from the Web browser, the operation after downloading the setting program 122 is performed by simply clicking the mouse, and the parameter setting of the device 2 is easy.

Further, since the operation does not depend on another manager such as the manager of the DHCP server and the like, it is possible to freely repeat the changing of the setting and the confirmation of the result.

Further, since a list of the devices which are targets of setting is shown and the targeted device can be selected, the input of the device ID can be eliminated, and thereby reducing the load of the user.

Further, since the PC on the same LAN, the PC sharing the network parameters such as the netmask, the proxy server URL, and the like with the targeted device of setting parameters is employed, the parameters set in the PC can be used, and thereby reducing the number of input items by the user.

Further, it is possible to prevent unnecessary disclosure of the installation environment of the device.

Since the proxy server URL as well as the IP address is set to the device, the device can promptly access the Web; that is, automatic software update and the like, which requires cooperation with the server on the Internet, can be used without complicated procedure.

Further, after completing the setting, since the device periodically accesses the server, alive monitoring of the device can be easily performed at the server side.

Since the setting items include the explanation character string, in case of new setting or in a case where the setting environment is changed, the correction can be easily done on the setting items and the explanation character strings; and thereby preventing the diremption between the reality and the record.

As discussed above, the present embodiment has explained a device parameter setting method including:

a device with a network function;

a server computer; and

a device setting computer connected to the device and the server computer via network,

wherein the server computer includes

a setting program generation means that receives identifying information which is unique to the device and parameter setting information for the device from the device setting computer, generates a setting program to have the device setting computer execute the parameter setting to the device, and sends the setting program to the device setting computer.

Further, the present embodiment has explained that

the server computer further includes:

a device information table storing at least one piece of identifying information of the device; and

device list display means sending a identifying information list of the device to the device setting computer based on the device information table,

wherein the server computer supplies the identifying information of the device selected by the user from the device identifying information list displayed on the device setting computer to the setting program generation means of the server computer.

Further, the present embodiment has explained that

the device information table includes information of the user who owns the device, and

the device list display means authenticates the user and displays only a list of devices owned by the user.

Further, the present embodiment has explained that

parameter information of the setting program includes an IP address.

Further, the present embodiment has explained that

the parameter information of the setting program includes an explanation character string which does not affect the operation of the device but is used by the user to understand the setting status of the device.

Further, the present embodiment has explained that

the setting program adds the parameter information stored in the device setting computer to the parameter setting information.

Further, the present embodiment has explained that

the parameter information stored in the device setting computer includes at least one of a netmask, a default gateway IP address, and a proxy server URL.

Further, the present embodiment has explained that

the setting program sends out the parameter setting information for the device using a broadcast address.

Further, the present embodiment has explained that

the parameter setting information includes the device identifying information, and

the device, in a case where the device identifying information among the parameter setting information received from the network does not specify the device itself, does not execute the parameter setting.

Further, the present embodiment has explained that

the setting program instructs the device to execute a registration process to the server computer at a predetermined intervals after setting the parameters.

Further, the present embodiment has explained that

the device information table stores a time when the last registration process is carried out by the device, and the device list display means display so as to identify the device which has carried out the registration process within a predetermined length of time from the current time.

### Embodiment 2

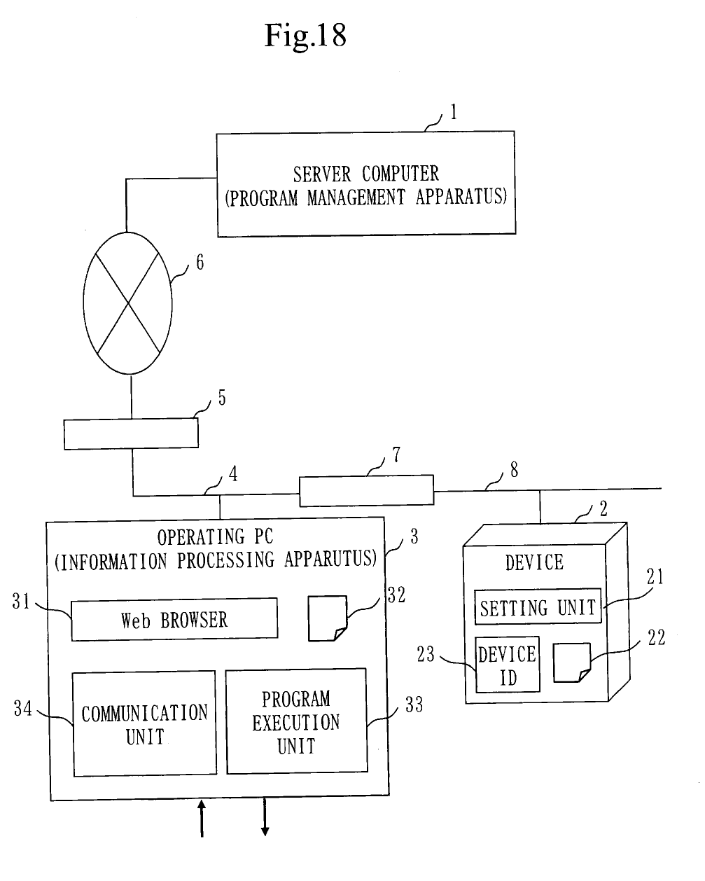

FIG. 18 shows a configuration example of a parameter setting system according to the present embodiment.

Different from FIG. 1, the LAN 8, to which the device 2 is connected, is connected to the LAN 4, to which the PC 3 is connected, via the network router apparatus 7.

In this case, when the PC 3 broadcasts the parameter setting request message 131, a directed broadcast has to be used with consideration of the network address of the LAN 8.

Note that the internal configuration of the server computer 1, the PC 3, and the device 2 are the same as the ones shown in the first embodiment.

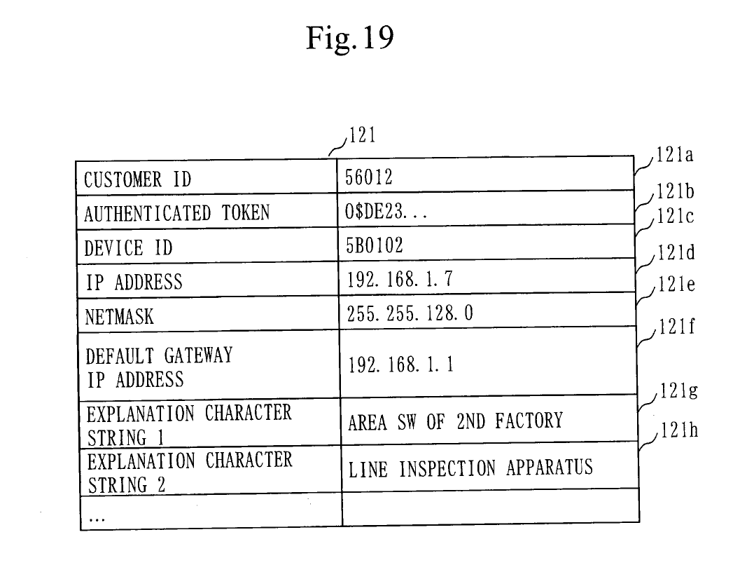

FIG. 19 illustrates the setting program generation request 121 to be received by the setting program generation unit 12 of the server computer 1 in the present embodiment.

Different from FIG. 9, the setting program generation request 121 of FIG. 19 includes a netmask 121e and a default gateway IP address 121f.

Since these are not shared between the networks separated by the network router apparatus 7, the user has to directly specify the netmask 121e and the default gateway IP address 121f using the input interface being the same with the screen 151.

The server computer 1, the PC 3, and the device 2 carries out the same operation as the first embodiment based on the setting program generation request 121 illustrated in FIG. 19 to set the parameter to the device 2.

As has been discussed, according to the present embodiment, the netmask and the default gateway IP address of LAN to which the device is connected are specified by the user, which brings the effect that the parameters can be set to the device connected to a subnetwork being different from that of the PC.

Further, in a case where the user does not specify the netmask or the default gateway IP address, the value of the PC setting parameter 32 of the PC 3 is used, and thereby the embodiment can be applied to a case where the PC 3 and the device 2 are connected to the same LAN.

The present embodiment has explained that

the setting program sends out the parameter setting information for the device using the directed broadcast address derived from the IP address and the netmask of the device.

### Embodiment 3

In the present embodiment, expiration time information is included in the parameter region 124, and as well an electronic signature by the server computer 1 for the parameter region 124 as a whole is provided to the setting program 122, thereby preventing abuse or misuse of the setting program 122.

That is, the server computer 1 appends the expiration time information and the electronic signature for the parameters of the parameter region 124 to the setting program 122, and sends the setting program 122 to which the expiration time information and the electronic signature are appended to the PC 3.

The PC 3 receives the setting program 122 to which the expiration time information and the electronic signature are appended from the server computer 1.

In addition, the PC 3 executes the received setting program 122, generates a parameter setting request message 131 including the expiration time information and the electronic signature which are appended to the setting program 122, and sends the parameter setting request message 131 including the expiration time information and the electronic signature to the device 2.

The device 2, at the step S23 of FIG. 15, verifies the electronic signature and compares the current time and the expiration time.

The internal configuration of the server computer 1, the PC 3, and the device 2 are the same as the ones shown in the first embodiment.

Further, except for the above operation, the operation of the server computer 1, the PC 3, and the device 2 are the same as ones shown in the first embodiment.

As has been discussed, according to the present embodiment, the verification of the electronic signature of the parameter region 124 and the confirmation of the expiration time of the parameter region 124 are carried out, which brings the effect to prevent alteration of the parameter setting by the falsified parameter setting request message 131 or the expired message, and to improve the safeness of the device.

The present embodiment has explained that the parameter setting information includes the expiration time and the electronic signature for the parameter setting information containing the expiration time, the device does not set the parameter in a case where the verification of the electronic signature fails among the parameter setting information received from the network, and in a case where the expiration time is prior to the current time, the parameter setting is not carried out.

### Embodiment 4

Different from the above embodiments, in the present embodiment, the setting program generation unit 12 generates, as one of the parameters, an SSL client certificate to be provided to the device 2, and outputs the SSL client certificate by embedding it in the parameter region 124.

That is, according to the present embodiment, the server computer 1 generates the SSL client certificate (electronic certificate) of the device 2, appends the generated SSL client certificate to the setting program 122, and sends the setting program 122 to which the SSL client certificate is appended to the PC 3.

Then, the PC 3 receives the setting program 122 to which the SSL client certificate is appended from the server computer 1, executes the received setting program 122, and generates a parameter setting request message 131 including the SSL client certificate appended to the setting program 122.

Then, the parameter setting request message 131 is sent to the device 2.

This operation enables secure communication between the device 2 and the server computer 1 directly after the setting.

The present embodiment has explained that

the setting program generation means generate information for the operating PC to authenticate the device and add the generated information to the parameter setting information.

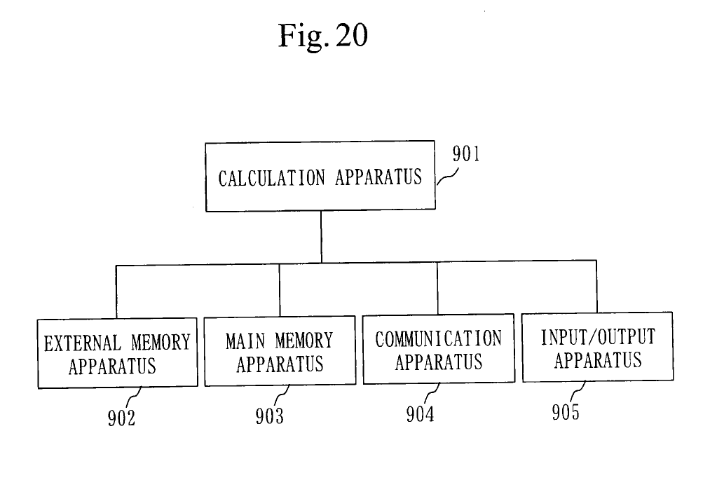

Finally, an example of the hardware configuration of the server computer 1, the device 2, and the PC 3 (hereinafter, referred to as the server computer 1 and the like) shown in the first to fourth embodiments will be explained with reference to FIG. 20.

As discussed above, the server computer 1 and the like is a computer, and each component of the server computer 1 and the like can be implemented by programs.

As for the hardware configuration of the server computer 1 and the like, a calculation apparatus 901, an external memory apparatus 902, a main memory apparatus 903, a communication apparatus 904, an input/output apparatus 905 are connected to a bus.

Note that the device 2 is not provided with the input/output apparatus 905 as a console apparatus.

The calculation apparatus 901 is a CPU executing programs.

The external memory apparatus 902 is, for instance, a ROM, a flush memory, and a hard disk drive.

The main memory apparatus 903 is a RAM.

The communication apparatus 904 is, for instance, a NIC (Network Interface Card).

The input/output apparatus 905 is, for instance, a mouse, a keyboard, a display apparatus, and the like.

Programs are usually stored in the external memory apparatus 902; the programs are loaded to the main memory apparatus 903, sequentially read and executed by the calculation apparatus 901.

The programs are to execute the functions that have been explained in FIGS. 1 and 2 as “unit”.

In addition, the external memory apparatus 902 also stores an operating system (OS); at least a part of the OS is loaded to the main memory apparatus 903, and while executing the OS, the calculation apparatus 901 executes the programs implementing the functions of “unit” illustrated in FIG. 1.

Further, the main memory apparatus 903 store information, data, signal values, or variable values showing the result of processing that have been explained in the first to fourth embodiments as “determination of”, “discrimination of”, “extraction of”, “setting of”, “registration of”, “selection of”, “generation of”, “creation of”, “update of”, “reception of”, “output of”, and the like as files.

Here, the configuration of FIG. 20 merely illustrates an example of the hardware configuration of the server computer 1 and the like; the hardware configuration of the server computer 1 and the like is not limited to the configuration of FIG. 20, but can be another configuration.

The foregoing has explained the embodiments of the present invention; out of these embodiments, two or more embodiments can be combined and implemented.

Or, it is also possible to implement partially one of these embodiments.

Or, it is also possible to combine partially and implement two or more of these embodiments.

Note that the present invention is not limited to these embodiments, but can be altered in a various way according to the necessity.

### REFERENCE SIGNS LIST

1: server computer; 2: device; 3: operating PC; 4: LAN; 5: network router apparatus; 6: external network; 7: network router apparatus; 8: LAN; 11: dispatch unit; 12: setting program generation unit; 13: setting program execution codes; 14: device registration unit; 15: device list display unit; 16: user authentication unit; 17: device information table; 18: user information table; 19: table management unit; 21: setting unit; 22: setting parameter; 23: device ID; 31: Web browser; 32: PC setting parameter; 33: program execution unit; and 34: communication unit.

1-9. (canceled)

10. A parameter setting system comprising:
a program management apparatus that manages a setting program which is used for setting a parameter; and
an information processing apparatus that conducts communication with the program management apparatus and a parameter-unset device to which a communication parameter has not yet been set, the information processing apparatus being able to execute the setting program,
wherein the information processing apparatus requests the program management apparatus to send the setting program, and as well sends to the program management apparatus the communication parameter to be set to the parameter-unset device,
wherein the program management apparatus appends the communication parameter received from the information processing apparatus to the setting program, and sends the setting program to which the communication parameter is appended to the information processing apparatus based on a request from the information processing apparatus, and
wherein the information processing apparatus receives the setting program to which the communication parameter is appended from the program management apparatus, executes the received setting program, generates a parameter setting request message that includes a setting target parameter having the communication parameter to be set to the parameter-unset device and requests setting of the setting target parameter, and sends the generated parameter setting request message to the parameter-unset device.

11. The parameter setting system of claim 10,
wherein the information processing apparatus is able to conduct communication with the parameter-unset device using a broadcast address, and sends the parameter setting request message including the communication parameter as the setting target parameter to the parameter-unset device using the broadcast address.

12. The parameter setting system of claim 10,
wherein the information processing apparatus, upon requesting the program management apparatus to send the setting program, sends the communication parameter as a first communication parameter to the program management apparatus, and stores a second communication parameter which is a different communication parameter from the first communication parameter in a predetermined memory region,
wherein the program management apparatus appends the first communication parameter received from the information processing apparatus to the setting program, and sends the setting program to which the first communication parameter is appended to the information processing apparatus, and
wherein the information processing apparatus receives, from the program management apparatus, the setting program to which the first communication parameter is appended, executes the received setting program, and generates a parameter setting request message including as the setting target parameter the first communication parameter appended to the setting program and the second communication parameter stored in the memory region.

13. The parameter setting system of claim 12,
wherein the first communication parameter is a communication parameter being unique to the parameter-unset device, and the second communication parameter is a communication parameter being common to a plurality of devices including the parameter-unset device.

14. The parameter setting system of claim 10,
wherein the program management apparatus appends expiration time information and an electronic signature for the setting target parameter to the setting program, and sends the setting program to which the expiration time information and the electronic signature are appended to the information processing apparatus, and
wherein the information processing apparatus receives the setting program to which the expiration time information and the electronic signature are appended from the program management apparatus, executes the received setting program, and generates a parameter setting request message including the expiration time information and the electronic signature which are appended to the setting program.

15. The parameter setting system of claim 10,
wherein the program management apparatus generates an electronic certificate of the parameter-unset device, appends the generated electronic certificate to the setting program, and sends the setting program to which the electronic certificate is appended to the information processing apparatus, and
wherein the information processing apparatus receives from the program management apparatus the setting program to which the electronic certificate is appended, executes the received setting program, and generates a parameter setting request message including the electronic certificate appended to the setting program.

16. The parameter setting system of claim 10,
wherein the information processing apparatus executes the setting program, and generates a parameter setting request message including as the setting target parameter at least one of an IP (Internet Protocol) address, a netmask, a default gateway IP address, and a proxy server URL (Uniform Resource Locator) of the parameter-unset device.

17. The parameter setting system of claim 10,
wherein an IP (Internet Protocol) address of the parameter-unset device is unset, and
wherein the communication parameter is a communication parameter that enables the parameter-unset device to conduct communication using the IP address.

18. The parameter setting system of claim 10,
wherein the communication parameter is a communication parameter that enables the parameter-unset device to access an external network.

19. A program management apparatus managing a setting program which is used for setting a parameter, the program management apparatus comprising:
a communication apparatus that conducts communication with an information processing apparatus which is able to execute the setting program for setting a communication parameter to a parameter-unset device to which the communication parameter has not been set, receives, from the information processing apparatus, a sending request of the setting program and the communication parameter to be set to the parameter-unset device, and sends the setting program to the information processing apparatus, and
a setting program generating circuit that appends the communication parameter received from the information processing apparatus through the communication apparatus to the setting program based on the sending request from the information processing apparatus, generates the setting program to which the communication parameter is appended, the setting program to generate a parameter setting request message which includes a setting target parameter having the communication parameter to be set to the parameter-unset device and to send the generated parameter setting request message to the parameter-unset device, by execution of the information processing apparatus.

20. An information processing apparatus communicating with a program management apparatus that manages a setting program which is used for setting a parameter and with a parameter-unset device to which a communication parameter has not been set, the information processing apparatus being able to execute the setting program, the information processing apparatus comprising:
a communication circuit that requests the program management apparatus to send the setting program, as well sends the communication parameter to be set to the parameter-unset device to the program management apparatus, receives from the program management apparatus the setting program to which the communication parameter is appended by the program management apparatus based on the request to send the setting program, and sends a parameter setting request message to the parameter-unset device; and
a program execution circuit that executes the setting program received by the communication circuit, and generates the parameter setting request message which includes a setting target parameter having the communication parameter to be set to the parameter-unset device and which requests to set the setting target parameter.
